(19) United States
(12) Patent Application Publication
(10) Pub. No.: US 2007/0192097 A1
(43) Pub. Date: Aug. 16, 2007

(54) METHOD AND APPARATUS FOR DETECTING AFFECTS IN SPEECH

(75) Inventors: Changxue C. Ma, Barrington, IL (US); Rongqing Huang, Schaumburg, IL (US)

Correspondence Address: MOTOROLA, INC., 1303 EAST ALGONQUIN ROAD, IL01/3RD, SCHAUMBURG, IL, 60196, US

(73) Assignee: MOTOROLA, INC., Schaumburg, IL (US)

(21) Appl. No.: 11/275,350

(22) Filed: Feb. 14, 2006

(51) Int. Cl. G10L 15/00

(52) U.S. Cl. 704/239

(57) ABSTRACT

A method and apparatus for speaker independent real-time affect detection includes generating (205) a sequence of audio frames from a segment of speech, generating (210) a sequence of feature sets by generating a feature set for each frame, and applying (215) the sequence of feature sets to a sequential classifier to determine a most likely affect expressed in the segment of speech.

### FIELD OF THE INVENTION

The present invention relates generally to speech recognition, and more particularly to a form of speech recognition that detects affects.

### BACKGROUND

Human affects are closely related to human emotions, but may include states of human behavior that may not normally be described as emotions. In particular, a balanced or neutral state may be not be conceived by some people as an emotion. Another example may be a behavior that is classified as “calculating” Thus, the more general term “affect” is used herein to include emotional and other states of human behavior.

The ability to determine the affect of a person can be helpful or even very important in certain situations. For example, the ability to determine an angry state of a driver could be used to reduce the probability of an accident that is caused by the direct or side affects of the anger, such as by alerting the driver to calm down. One aspect of human behavior that could be useful to determine the affect of a person is a change of speech characteristics that occurs when the person's affect changes. However, the benefits available from determining a person's affect are difficult to achieve using current methods of detecting a persons affect from the person's speech, because the methods use static methods (i.e, statistics) of speech signal characteristics, which are difficult to be implemented in real-time and are not very reliable.

### BRIEF DESCRIPTION OF THE FIGURES

The accompanying figures, where like reference numerals refer to identical or functionally similar elements throughout the separate views, together with the detailed description below, are incorporated in and form part of the specification, and serve to further illustrate the embodiments and explain various principles and advantages, in accordance with the present invention.

FIG. 1 is a block diagram of an electronic device, in accordance with some embodiments of the present invention;

FIG. 2 is a flow chart that shows some steps of a method for speaker independent real-time affect detection, in accordance with some embodiments of the present invention;

FIG. 3 is a table that shows results of performance testing of a model of an embodiment of the present invention in comparison to a model of a prior art system; and

FIG. 4 is a graph that shows comparisons of the performance of models of two embodiments of the present invention in comparison to models of six prior art systems.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

### DETAILED DESCRIPTION

Before describing in detail embodiments that are in accordance with the present invention, it should be observed that the embodiments reside primarily in combinations of method steps and apparatus components related to detection of human affects from speech. Accordingly, the apparatus components and method steps have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

In this document, relational terms such as first and second, top and bottom, and the like may be used solely to distinguish one entity or action from another entity or action without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “comprises . . . a” does not, without more constraints, preclude the existence of additional identical elements in the process, method, article, or apparatus that comprises the element.

Speech and its features are dynamical in nature. It is preferable to capture the dynamical changes by tracking the evolving contours of the features, such as the pitch contour or intonation rather than a signal statistic value for the speech segments. It will be seen from the details that follow that a novel approach using this technique provides substantial benefits in comparison to prior art approaches.

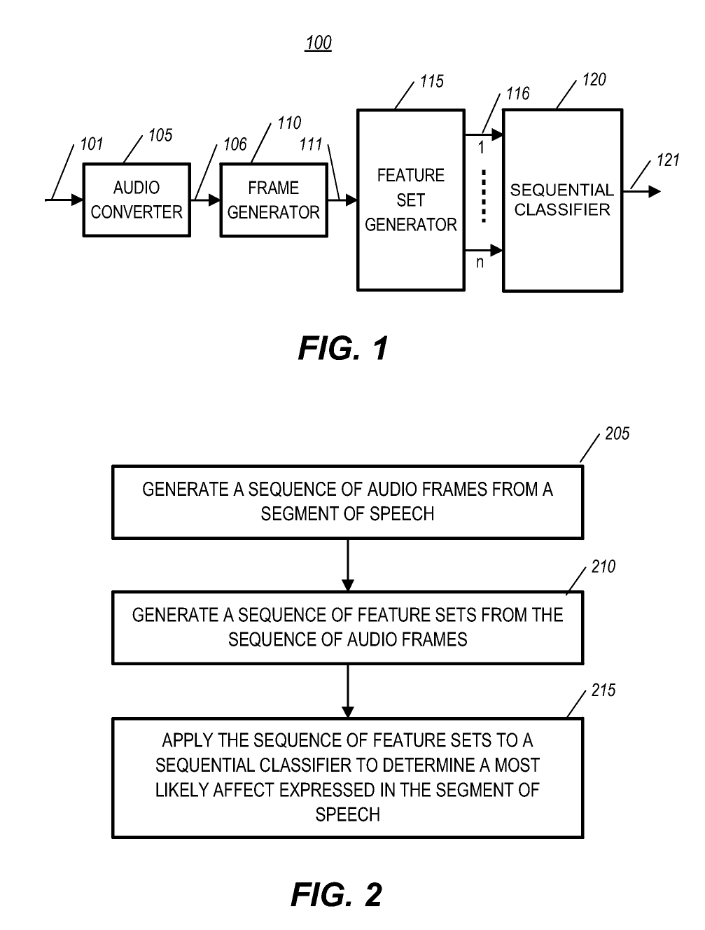

Referring to FIG. 1, a block diagram of an electronic device 100 is shown, in accordance with some embodiments of the present invention. The electronic device 100 comprises an audio converter 105, a frame generator 110, a feature set generator 115 and a sequential classifier 120, and typically comprises many other functions not shown in FIG. 1. The electronic device 100 may be any of a wide variety of types of electronic devices, such as a toy, a handheld communicator, or a driver advocacy computer for a consumer, commercial, or military vehicle. The audio converter 105 receives a speech signal 101 at a transducer and generates an analog electrical signal 106 representing the speech signal that is coupled to the frame generator 110. This analog electrical signal 106 may be generated using well known or new techniques. The frame generator 110 converts the analog signal into a sequence of digitized values at a rate, such as 8,000 times per second, that are then grouped into frames that each consist of sequences of the digitized values that represent, for example, 10 to 30 milliseconds of the analog electrical signal 106. These frames may be generated using well known or new techniques. These frames are coupled to the feature set generator 115, which generates a feature set for each frame.

The feature sets include values that may be generated using known or new techniques. Each feature set may include any one or more of the following values (also called features): a count of zero crossings in the frame, an energy of the frame, a pitch value of the frame, and a value of spectral slope of the frame. The feature sets are grouped into sequences of features sets 116 that represent a segment of speech. The segment of speech may be a segment that represents a word or phrase. The segment boundaries may be determined, for example, by the feature set generator 115 from a feature such as the energy of each frame, by searching for a sequential group of frames having an energy level above a certain value and classifying each such group as a segment of speech. The segments could be determined in another manner, such as analog circuitry in the audio converter 105.

The feature sets for an audio segment of speech 116 are then applied to the sequential classifier 120. The sequential classifier 120 uses each sequential feature set to determine a most likely affect 121. The sequential classifier 120 may be a hidden Markov model classifier, or one of another type of sequential classifier, such as a Time-Delay Neural Network. The sequential classifier may be set up using a set of emotional speech databases. These databases consist of speech data from one or a plural number of speakers uttered in various affect states. The most likely affect 121 is coupled to another portion (not shown in FIG. 1) of the electronic device 100, or coupled to another device (not shown in FIG. 1), where it is used by an application. For example, when the electronic device 100 is a driver advocacy processor for a vehicle, and the affect is “anger”, then the driver advocacy processor may be programmed to provide an audible message to the driver of the vehicle that is intended to reduce the probability of an accident.

Referring to FIG. 2, a flow chart shows some steps of a method 200 for speaker independent real-time affect detection, in accordance with some embodiments of the present invention. The method may be accomplished by an electronic device such as the electronic device described above with reference to FIG. 1. At step 205, a sequence of audio frames is generated from a segment of speech. As for the electronic device 100, each audio frame may comprise digital samples of a portion of an analog signal of the segment of speech that may have a duration, for instance, in a range of 10 to 30 milliseconds. At step 210, a sequence of feature sets is generated from the sequence of audio frames. The sequence of feature sets includes at least one sequence of a feature set that is one of a zero crossing count, energy value, pitch value, and a value of spectral slope. The sequence of feature sets is applied to a sequential classifier at step 215 to determine a most likely affect expressed in the segment of speech. The sequential classifier may be of any of the types described above with reference to FIG. 1.

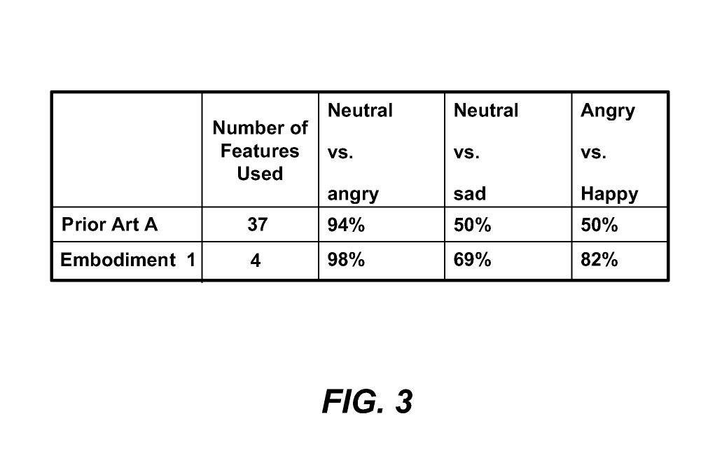

Referring to FIG. 3 a table shows results of performance testing of a model of an embodiment of the present invention (identified as Embodiment 1 in FIG. 3) in comparison to a model of a prior art system (identified as Prior Art A). The prior art system makes a decision based on statistical characteristics of 37 features derived form a same segment of audio during which the embodiment of the present invention provides a sequence of feature sets, in which each feature set includes 4 features, to a sequential classifier. The systems are tested with a statistically valid quantity of audio segments. The Prior Art A system and the Embodiment 1 are each optimized for making a decision between two emotions at a time, for three pairs of emotions as shown in FIG. 3. It will be appreciated that Embodiment 1 outperforms Prior Art A in all cases. The “optimization” of Embodiment 1 comprised setting up the hidden Markov model using more data collected from users and adapting the classifier accordingly.

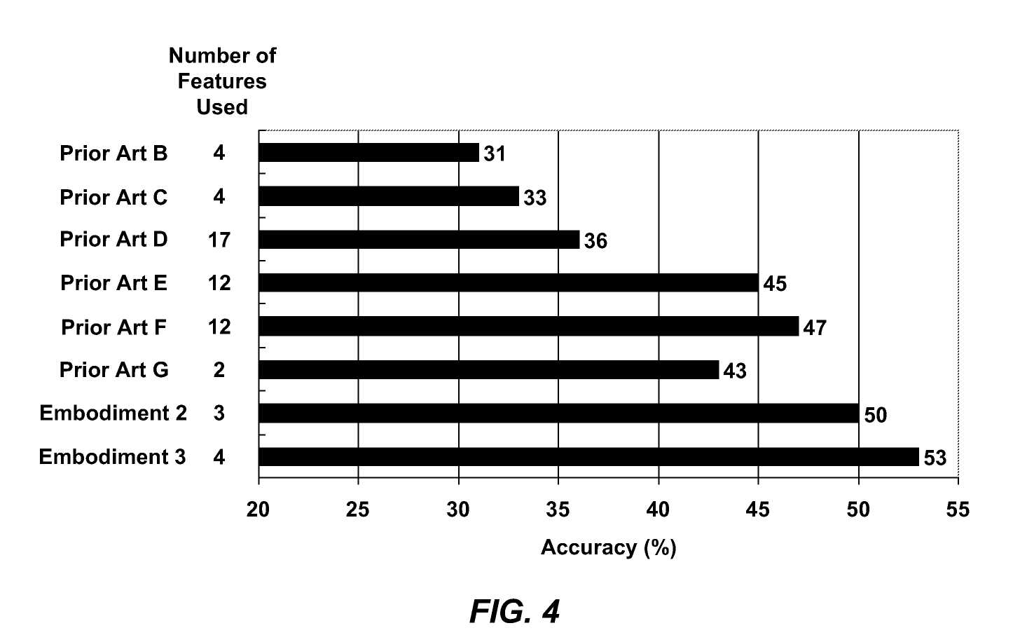

Referring to FIG. 4, a graph shows comparisons of the performance of models of two embodiments of the present invention (identified as Embodiment 2 and Embodiment 3 in FIG. 4) in comparison to models of six prior art systems (identified as Prior Art B through Prior Art G in FIG. 4). The prior art systems make a decision based on statistical characteristics of a quantity of features identified in FIG. 4 that are derived from a same segment of audio during which the embodiment of the present invention provides a sequence of feature sets to a sequential classifier. Embodiments 2 uses 3 features in each feature set while Embodiment 3 uses 4 features in each feature set. The systems are tested with a statistically valid quantity of audio segments. The Prior Art systems and the Embodiment 1 and Embodiment 2 are each optimized for making a decision between five emotions at a time (neutral, boredom, anger, happiness, and sadness). The bars show the accuracy of the tested performance of each system. It will be appreciated that Embodiments 2 and 3 outperform all modeled Prior Art embodiments. A further “optimization” of Embodiments 2 and 3 comprised setting up the hidden Markov model using adaptation based on data from the user.

It will be appreciated that embodiments of the invention described herein may be comprised of one or more conventional processors and unique stored program instructions that control the one or more processors to implement, in conjunction with certain non-processor circuits, some, most, or all of the functions of the embodiments of the invention described herein. The non-processor circuits may include, but are not limited to, a radio receiver, a radio transmitter, signal drivers, clock circuits, power source circuits, and user input devices. As such, these functions may be interpreted as steps of a method to perform speech signal processing and data collection. Alternatively, some or all functions could be implemented by a state machine that has no stored program instructions, or in one or more application specific integrated circuits (ASICs), in which each function or some combinations of certain of the functions are implemented as custom logic. Of course, a combination of these approaches could be used. Thus, methods and means for these functions have been described herein. In those situations for which functions of the embodiments of the invention can be implemented using a processor and stored program instructions, it will be appreciated that one means for implementing such functions is the media that stores the stored program instructions, be it magnetic storage or a signal conveying a file. Further, it is expected that one of ordinary skill, notwithstanding possibly significant effort and many design choices motivated by, for example, available time, current technology, and economic considerations, when guided by the concepts and principles disclosed herein will be readily capable of generating such stored program instructions and ICs with minimal experimentation.

A few of many applications of the embodiments of the present invention include electronic devices that perform an advocacy function for vehicle operators; conversational aid applications that modify avatars based on a determination of a most likely affect; toys or tutors that respond to a determined affect, and an applicant that acts as an agent for the person from whose speech segment the most likely affect has been determined.

In the foregoing specification, specific embodiments of the present invention have been described. However, one of ordinary skill in the art appreciates that various modifications and changes can be made without departing from the scope of the present invention as set forth in the claims below. Accordingly, the specification and figures are to be regarded in an illustrative rather than a restrictive sense, and all such modifications are intended to be included within the scope of present invention. The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

1. A method for speaker independent real-time affect detection, comprising:
generating a sequence of audio frames from a segment of speech;
generating a sequence of feature sets by generating a feature set for each frame; and
applying the sequence of feature sets to a sequential classifier to determine a most likely affect expressed in the segment of speech.

2. The method according to claim 1, wherein each feature set in the sequence of feature sets includes one or more features, and wherein each feature is one of a zero crossing feature, an energy feature, a pitch feature, and a spectral slope feature.

3. The method according to claim 1, wherein the sequential classifier is a Hidden Markov Model classifier.

4. The method according to claim 1, further comprising using the most likely affect in an application.

5. An electronic device that detects affects, comprising:
a frame generator that generates a sequence of digitized audio frames from a segment of speech;
a feature set generator coupled to the frame generator that generates a sequence of feature sets by generating a feature set for each frame;
a sequential classifier coupled to the feature set generator for determining a most likely affect expressed in the segment of speech from the sequence of feature sets.

6. The electronic device according to claim 4, wherein each feature set in the sequence of feature sets includes one or more features, and wherein each feature is one of a zero crossing feature, an energy feature, a pitch feature, and a spectral slope feature.

7. The electronic device according to claim 5, wherein the sequential classifier is a Hidden Markov Model classifier.

8. The electronic device according to claim 5, further comprising an audio converter coupled to the frame generator that receives audio energy that includes the audio segment, and converts the energy to a series of digital values.

9. The electronic device according to claim 5, further comprising an application function that uses the most likely affect.

10. The electronic device according to claim 9, wherein the application function is one of a vehicle operator advocate, a toy, an avatar modifier, and a tutoring device.
